(19) United States
(12) Patent Application Publication
(10) Pub. No.: US 2003/0154983 A1
(43) Pub. Date: Aug. 21, 2003

(54) Personal air filtering device

(76) Inventor: Alvin J. Marx, San Antonio, TX (US)

Correspondence Address: Alvin J. Marx, MD, MBA, 511 Mirepoix, San Antonio, TX, 78232, US

(21) Appl. No.: 10/075,900

(22) Filed: Feb. 15, 2002

(51) Int. Cl. A62B 7/10; A62B 18/08

(52) U.S. Cl. 128/205.27; 128/205.28; 128/205.29; 128/206.12; 128/206.13

(57) ABSTRACT

Personal Air Filtering Device with a face mask comprised of nonporous material, the face mask held onto the user's head by standard elastic straps, the face mask having a flexible gasket about its perimeter to provide an airtight seal between the mask and the user's face, the face mask having a check valve that lets exhaled air out of the mask but does not let unfiltered air into the mask, a flexible tube that enters the face mask at one end and enters an air filtering assembly on the opposite end, said air filtering assembly enclosed in a housing, said housing having an air intake opening, and said air filtering assembly including an air moving device such as a fan or pump, a carbon filter cartridge, a particulate matter filter, a battery power supply, and an on-off switch. A preferred embodiment includes said flexible tube held onto the user's clothing by a neck clip.

### BACKGROUND OF THE INVENTION

This invention relates generally to the field of face masks, and more particularly to a personal air filtering device.

There are conditions that arrive, either natural or man made, that cause the air we breath to become polluted with various contaminants such as harmful particulate matter or gasses. Various types of face masks have been developed in the past that protect the user from airborne pollutants.

Dust masks have been developed to protect people from larger particulate matter such as sand, wood dust, metal dust or the like. These masks usually are made from non woven filter paper or woven cloth. They are held on with elastic bands. Other, more comprehensive filtering masks have been designed for removing particulate matter as well as some gasses. These are used to filter the fumes from spray paint and various harmful solvents and the like. These masks often include cartridges with filtering material such as activated charcoal. At the more extreme level, gas masks have been developed to protect people from potentially deadly gasses and particles that may include bacteria, viruses and the like. These masks are usually cover most of the face and made of a nonporous rubber material and include finer gas and particle filtering elements.

Although the above mentioned masks have proven to be effective for their intended uses, current uses require an improved and novel configuration that cannot be found in the existing units. Currently, there are many locations in the world where the ambient air, that is, the air we normally breath while walking down the street, may be harmful to one's health. It contains harmful byproducts that are generated by vehicle and factory emissions as well as sprays of pesticides whose harmful particles carryover to populated areas. Most recently, the danger of weapons grade spores of Anthrax particles released by terrorists has caused people to want to protect themselves from potentially inhaling these deadly bacteria. The anthrax partile can be as small as two tenths of one micron in diameter. Particles of this size are made by chemically dhanging so that there are less adherent to each other. These changed spores are then mixed with a powder. Although there are types of military gas masks that may protect a person from the above mentioned pollutants, they tend to be cumbersome and expensive to manufacture and purchase. Additionally, they are unacceptable from a fashion point of view, for wearing under every day conditions. It would certainly turns heads to see a person walking down the street wearing a military style gas mask. Finally, current designs of most filtering masks cause a build up of carbon dioxide between the inside of the mask and the user's face because the introduction of fresh air is somewhat limited by the construction of the mask. This fact makes it uncomfortable to wear such a mask for prolonged periods of time such as when walking for long periods outdoors, standing in the operating room, or the like.

### SUMMARY OF THE INVENTION

The primary object of the invention is to provide a personal air filtering device that is portable and can be worn for continuous periods of time.

Another object of the invention is to provide a personal air filtering device that delivers a substantial amount of fresh air by drawing or forcing air into a filter and delivering it to a mask portion that fits snuggly on a user's face.

Another object of the invention is to provide a personal air filtering device that is designed to create a relatively inconspicuous appearance so it that does not draw excessive attention to the wearer while using the present invention in public.

Another object of the invention is to provide a personal air filtering device that is relatively light weight and economical to manufacture.

Another object of the invention is to provide a personal air filtering device that is battery powered.

A further object of the invention is to provide a personal air filtering device that can protect the user from breathing in very fine airborne pollutants.

Other objects and advantages of the present invention will become apparent from the following descriptions, taken in connection with the accompanying drawings, wherein, by way of illustration and example, an embodiment of the present invention is disclosed.

Personal Air Filtering Device comprising: a face mask comprised of nonporous material, said face mask held onto the user's head by standard elastic straps, said face mask having a flexible gasket about its perimeter to provide an airtight seal between said mask and the user's face. Said face mask has an exit check valve that lets exhaled air out of the mask but does not let unfiltered air into the mask. There may also be a filter at the exit valve. A flexible tube that enters the face mask at one end and enters an air filtering assembly on the opposite end, said air filtering assembly enclosed in a housing, said housing having an air intake opening. Said air filtering assembly includes an air moving device such as a fan or pump, a carbon filter cartridge, a particulate matter filter, a battery power supply, and an on-off switch. The carbon intake filter can be designed to remove either two tenths of one micron particles or five to ten micron particles. The exit filter will remove five to ten micron particles.

The drawings constitute a part of this specification and include exemplary embodiments to the invention, which may be embodied in various forms. It is to be understood that in some instances various aspects of the invention shown may be exaggerated or enlarged to facilitate an understanding of the invention.

### BRIEF DESCRIPTION OF THE DRAWINGS

FIG. 1 is a perspective front view of a person wearing the personal air filtering device of the present invention.

FIG. 2 is a front view of the housing of the air filter of the present invention showing a carbon filter cartridge about to be inserted into the housing.

FIG. 3 is a perspective rear view of a person wearing the personal air filtering device of the present invention.

FIG. 4 is a side section view of the housing of the air filter of the present invention.

FIG. 5 is a front perspective view of a person wearing an anthrax filtering design of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims. Also these details represent the basis for teaching one skilled in the art to employ the present invention in virtually any appropriate system, structure or manner.

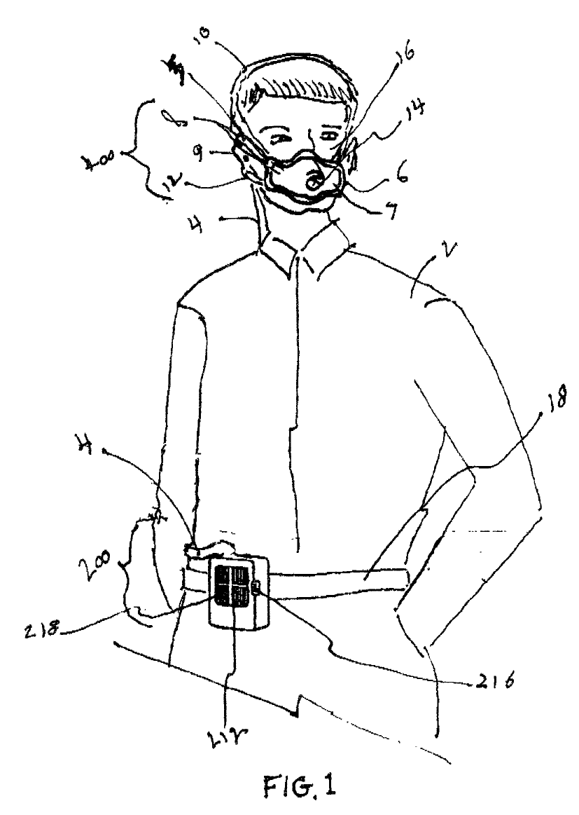

Referring now to FIG. 1 we see a perspective view of a person 2 wearing the air filter assembly 200 and mask assembly 400 of the present invention. The mask assembly 400 is comprised of a nonporous contoured shell 7 that can be made of rigid or resilient material. One embodiment envisioned uses clear plastic material for the the contoured shell 7 so that there is minimum imposition on the normal appearance of the wearer. A resilient gasket 6 surrounds shell piece 7 and is sufficient to create an airtight seal between the shell piece 7 and the user's face 16. A one-way valve 14 allows the user to breath out expired air through the valve 14 but not to breath air into the valve 14. Adding a filter after the one-way valve would protect a patient from the exhaled air of operating room personnel. Air tube portion 5 is contoured to fit neatly around the user's ear 9 and to enter the mask shell 7 at point 8. Mask shell 7 and surrounding gasket 6 are held onto the user's face 16 by elastic bands 12, 10 that are configured in the standard way that many current masks use. The elastic band 12 surrounds the user's neck and elastic band 10 surrounds the top portion of the user's head. Form fitting tube 5 connects directly to flexible air tube 4 that travels down the user's back and curves around the user's waist and into air filter assembly 200. The assembly 200 is worn on belt 18 or as a vest. Housing 210 has an opening 218 in its front surface to allow air to enter into carbon filter cartridge 212. Tab 216 allows the user to pull out cartridge 212 for replacement when the carbon in the cartridge 212 is saturated.

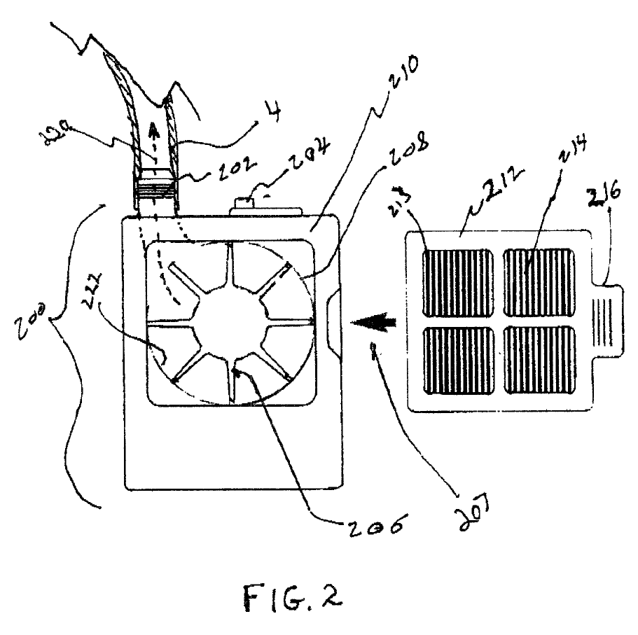

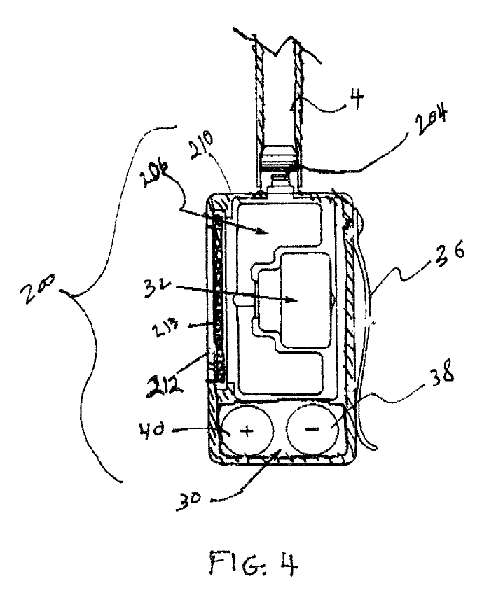

FIG. 2 shows a front view of the air filter assembly 200 and the carbon filter cartridge 212. This filter should remove particles of five to ten microns in size. The cartridge 212 is a hollow box like structure whose front and back panels have plurality of finely spaced ribs 214 separated by gaps that let air pass into and through the carbon granules 213 located within the the cartridge 212. The cartridge 212 plugs into air filter housing 210 as indicated by arrow 207. Tab 216 helps the user pull cartridge 212 out of the housing 210. Impeller 206 spins and causes air to be drawn into housing 20, through cartridge 212, along wall 208 and up through air tube 4 as indicated by dotted line 220. Switch 204 turns motor 32 on and off as shown in FIG. 4

FIG. 4 also shows a side section view of air filter assembly 200. Batteries 38, 40 power motor 32 which spins impeller 206 causing air to be drawn into cartridge 212 as described above. Spring clip 36 holds the assembly 200 onto the user's belt.

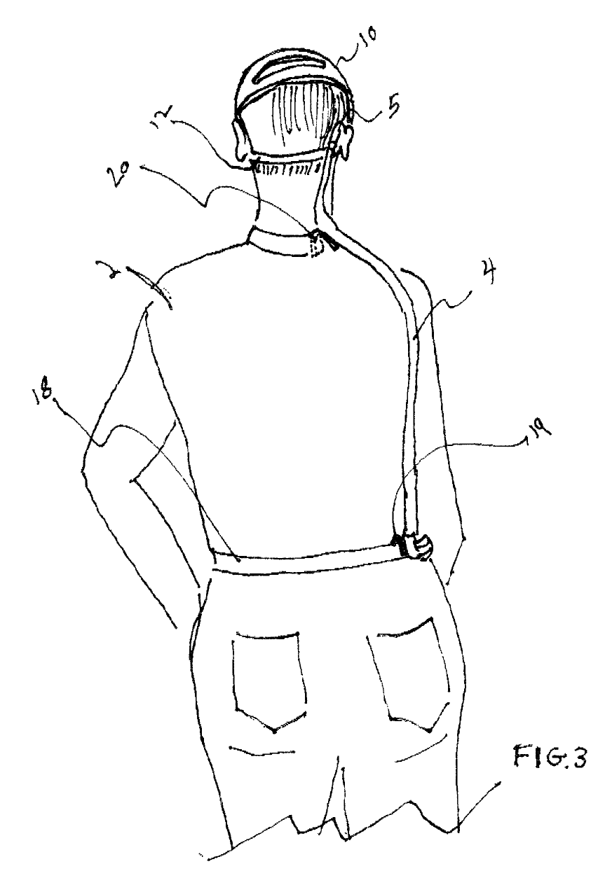

Referring back to FIG. 3 we see a rear view of the user wearing the air filter of the present invention. Tube 4 is shown running up the back and side portion of the user's torso. Tube support clip 19 helps hold tube 4 in place near its lower portion. Shirt clip 20 holds tube 4 in place near its upper portion, Tube portion 5 is made of rigid material so that it can closely follow the contour of the user's ear and face. Straps 10 and 12 can be clearly seen holding the mask assembly 400 in place on the user's head.

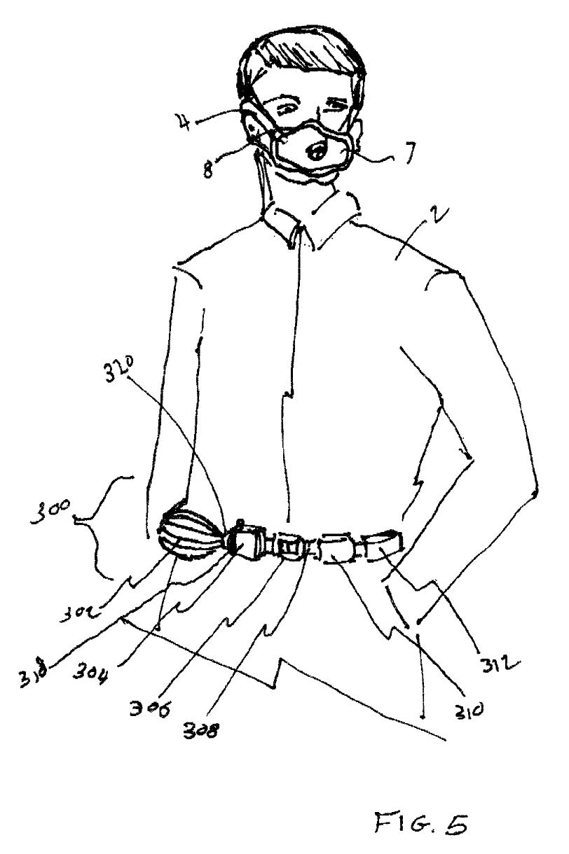

FIG. 5 shows an alternate embodiment of the present invention where a rotary vane pump 306 such as the series 3600 pump made by Procon of Murfeesboro, Tenn., pumps air through a one tenth of one micron filter 318 such as the microfilter element made by Meissner Filtration of Camarillo, Calif. This filter should remove weapons grade Anthrax as small as two tenths of a micron. Additionally, an activated carbon adsorber 320 will be employed to remove trace organics. One such carbon filter is the Nitox filter made by Tigg Corporation of Herber Springs Ariz. The air is pumped into a flexible bladder 302 such as the one made by Perma-Type Rubber Corporation of Plainville, Conn. The bladder 302 collects air as the user exhales and supplies the air up air tube 4 and into mask assembly 400 as the user breaths in. Battery packs 310, 312 power the pump 304. The entire assembly is attached to belt 308 which is secured by belt buckle 306. This embodiment as shown in FIG. 5 is designed to filter the finest airborne particles including Anthrax.

The above descriptions and illustrations show a unique portable air filtration system that can be worn by a person for extended periods of time. The entire assembly is relatively unobtrusive in appearance and can therefore be worn in normal public locations without embarrassment. The assembly is designed to be relatively inexpensive to manufacture and yet effective enough to potentially save the life of the user when exposed to harmful and potentially deadly particles floating in the ambient air.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Personal Air Filtering Device comprising:
a face mask comprised of non porous material;
said face mask held onto the user's head by standard elastic straps;
said face mask having a flexible gasket about its perimeter to provide an airtight seal between said mask and the user's face;
said face mask having a check valve that lets exhaled air out of the mask but does not let unfiltered air into the mask;
a flexible tube that enters the face mask at one end and enters an air filtering assembly on the opposite end;
said air filtering assembly enclosed in a housing;
said housing having an air intake opening; and
said air filtering assembly including an air moving device such as a fan or pump, a carbon filter cartridge, a particulate matter filter, a battery power supply, and an on-off switch.

2. Personal Air Filtering Device as claimed in claim 1 wherein said flexible tube is held to the user's clothing by a neck clip.

3. Personal Air Filtering Device as claimed in claim 1 wherein said air filtering assembly is removably attached to the user's body by a belt.

4. Personal Air Filtering Device as claimed in claim 1 wherein said air moving device is a rotary vane pump that can force said incoming air through a one tenth of one micron filter.

5. Personal Air Filtering Device as claimed in claim 1 wherein said filtered air can be collected in a flexible reservoir that retains said air during the exhaled breath and releases said air during the inhaled breath.
